(19) United States
(12) Patent Application Publication
(10) Pub. No.: US 2010/0134457 A1
(43) Pub. Date: Jun. 3, 2010

(54) DISPLAY DEVICE

(76) Inventors: Hiromi Katoh, Osaka (JP); Kazuhiro Maeda, Osaka (JP); Christopher Brown, Oxford (GB)

Correspondence Address: NIXON & VANDERHYE, PC, 901 NORTH GLEBE ROAD, 11TH FLOOR, ARLINGTON, VA, 22203, US

(21) Appl. No.: 12/595,116

(22) PCT Filed: Apr. 3, 2008
(86) PCT No.: PCT/JP2008/056703

§ 371 Date: Oct. 8, 2009

(30) Foreign Application Priority Data
Apr. 9, 2007 (JP) 2007-02138

(51) Int. Cl. G09G 5/00

(52) U.S. Cl. 345/207

(57) ABSTRACT

The present invention provides a display device with an image capture function including optical sensors in its pixels, in particular, a display device which allows a reduction in the size of a substrate and in power consumption by reducing the area of a peripheral region not contributory to displaying. The display device includes: an active matrix substrate (100) including a plurality of gate lines (7), a plurality of source lines (9), and display switching elements arranged in correspondence with respective points of intersection of the plurality of gate lines and the plurality of source lines. The display device further includes: optical sensors (10) provided in a pixel region (1) of the active matrix substrate (100); and a plurality of sensor row lines (8) arranged in correspondence with the optical sensors (10). Supply of a voltage to the optical sensors (10) and reading of a luminance signal from the optical sensors are performed through the plurality of source lines (9) by a common column driver circuit that drives the display switching elements.

### TECHNICAL FIELD

The present invention relates to display devices with an image capture function including optical sensors in the pixels, and in particular to a display device capable of capturing images which allows a reduction in the size of a substrate and in power consumption by reducing the area of a peripheral region not contributory to displaying.

### BACKGROUND ART

Conventionally, there have been proposed display devices with an image capture function capable of capturing images of objects in the proximity of their displays by means of, for example, optical sensors, such as a photodiode, provided in the pixels. Such display devices with an image capture function are intended to be used as display devices for interactive communications, display devices with a touchscreen function, etc.

In a conventional display device with an image capture function, photodiodes are formed in the pixels at the same time when well-known components such as signal lines, scan lines, thin film transistors (TFTs), and pixel electrodes are formed on an active matrix substrate using a semiconductor process (see Patent document 1 and Non-patent document 1).

Patent document 1: JP 2006-3857 A
Non-patent document “A Touch Panel Function Integrated LCD Including LTPS A/D Converter”, T. Nakamura et al., SID 05 DIGEST, pp. 1054-1055, 2005

### DISCLOSURE OF INVENTION

### Problem to be Solved by the Invention

In order to read signal charges in the form of luminance signals from the optical sensors provided in the pixels, the conventional display device with an image capture function include, in addition to a plurality of gate lines and source lines used to drive switching elements for displaying images, lines for the optical sensors arranged in a matrix that are used to drive the optical sensors to read the luminance signals.

Furthermore, a peripheral region of an image display region has been provided with a display gate driver and a display source driver for supplying a display signal for displaying images to each picture element formed in the image display region to drive display switching elements, and a sensor row circuit and a sensor column circuit for driving the optical sensors disposed in a matrix to read the luminance signals.

Such a conventional display device with an image capture function requires the driving circuits for displaying images and the circuits for driving the sensors and reading the signals in both row and column sides. As a result, the peripheral region, which surrounds the image display region and is not contributory to displaying images, needed to have an area with a certain size or more. Consequently, a so-called frame region becomes large, and hence the size of the active matrix substrate also becomes large in comparison with the size of a displayed image.

Furthermore, four driver circuits have been required, and they had to be placed on the peripheral region. Therefore, an enormous amount of power consumption has been required.

With the foregoing in mind, it is an object of the present invention to provide a display device with an image capture function including optical sensors in the pixels, and in particular a display device that allows a reduction in the size of the frame region by reducing the size of the peripheral region not contributory to displaying images and a reduction in power consumption at driver circuits.

### Means for Solving Problem

In order to solve the above problems, the present invention provides a display device that includes an active matrix substrate including a plurality of gate lines, a plurality of source lines, and display switching elements arranged in correspondence with respective points of intersection of the plurality of gate lines and the plurality of source lines. The display device further includes: optical sensors provided in a pixel region of the active matrix substrate; and a plurality of sensor row lines arranged in correspondence with the optical sensors. Supply of a voltage to the optical sensors and reading of a luminance signal from the optical sensors are performed through the plurality of source lines by a common column driver circuit that drives the display switching elements.

According to this configuration, it is possible to drive the optical sensors, read the luminance signals, and display images with the common column driver circuit through the plurality of source lines. Thus, the area of the peripheral region necessary for placing driver circuits can be reduced, and thereby the size of the frame region can be also reduced. Further, it is also possible to reduce power consumption at the driver circuits. Furthermore, since the number of electrodes formed in picture elements declines, the aperture can be improved.

It is preferable that the column driver circuit includes: a column scanning circuit for outputting a column selection signal, a sensor column reading circuit for supplying voltages to the optical sensors and reading the luminance signal on the basis of the column selection signal, and a display switching circuit for supplying an image display signal to the display switching elements on the basis of the column selection signal.

By configuring the column driver circuit in this way, it is possible to display images, read and output the luminance signals from the optical sensors in the column direction by a single driver circuit with efficiency.

Further, the display device of the present invention may further include: a counter substrate facing the active matrix substrate; and a liquid crystal layer interposed between the active matrix substrate and the counter substrate.

### EFFECTS OF THE INVENTION

As described above, according to the present invention, it is possible to provide a display device with an image capture function including optical sensors in its pixels, and in particular, a display device including an active matrix substrate with the size of the frame region being reduced due to a reduction in the area of the peripheral region.

### BRIEF DESCRIPTION OF DRAWINGS

FIG. 1 is a block diagram showing a schematic configuration of an active matrix substrate of a display device according to one embodiment of the present invention.

FIG. 2 is an equivalent circuit diagram showing a configuration of one pixel in the display device according to one embodiment of the present invention.

FIG. 3 is a diagram for describing driving of optical sensors included in the display device according to one embodiment of the present invention and an output from the optical sensors.

FIG. 4 is a circuit diagram showing a configuration of a column driving control circuit included in the display device according to one embodiment of the present invention.

FIG. 5 is a timing chart showing image display and operation of the optical sensors in the display device according to one embodiment of the present invention.

FIG. 6 is a circuit diagram showing a configuration of a column driving circuit included in a display device according to Embodiment 2 of the present invention.

FIG. 7 is a circuit diagram showing a configuration of a column driving circuit included in a display device according to Embodiment 3 of the present invention.

FIG. 8 is a circuit diagram showing the configuration of the column driving circuit included in the display device according to Embodiment 3 of the present invention.

FIG. 9 is a timing chart showing image display and operation of the optical sensors in the display device according to Embodiment 3 of the present invention.

FIG. 10 is an equivalent circuit diagram showing another configuration example of one pixel in the display device of the present invention.

FIG. 11 is an equivalent circuit diagram showing yet another configuration example of one pixel in the display device of the present invention.

FIG. 12 is a circuit diagram showing another configuration of a transistor that reads a signal of an optical sensor in the display device of the present invention.

### DESCRIPTION OF THE INVENTION

Hereinafter, embodiments of the present invention will be described with reference to the drawings.

It should be noted that the display device of the present invention is employed as a liquid crystal display device in the embodiments. The display device of the present invention, however, is not limited to a liquid crystal display device and can be used as a variety of display devices using an active matrix substrate, such as an EL display device and a field emission cold cathode display device. The display device of the present invention may be used as a display device with a touchscreen function in which input operation is performed by detecting an object in the proximity of the screen due to having an image capture function, a display device for interactive communications with both a display function and an image capture function, etc.

It should be noted, for each of the drawings, that only the main components among others in the embodiments of the present invention are shown in a simplified manner, for the purpose of convenience in explanation. Therefore, the display device of the present invention may include arbitrary components not shown in each of the drawings to be made reference in the specification. It should be noted also that the dimensions of the components in each of the drawings do not necessarily indicate the actual dimensions of the components and dimensional ratios among the respective components and the like.

### Embodiment 1

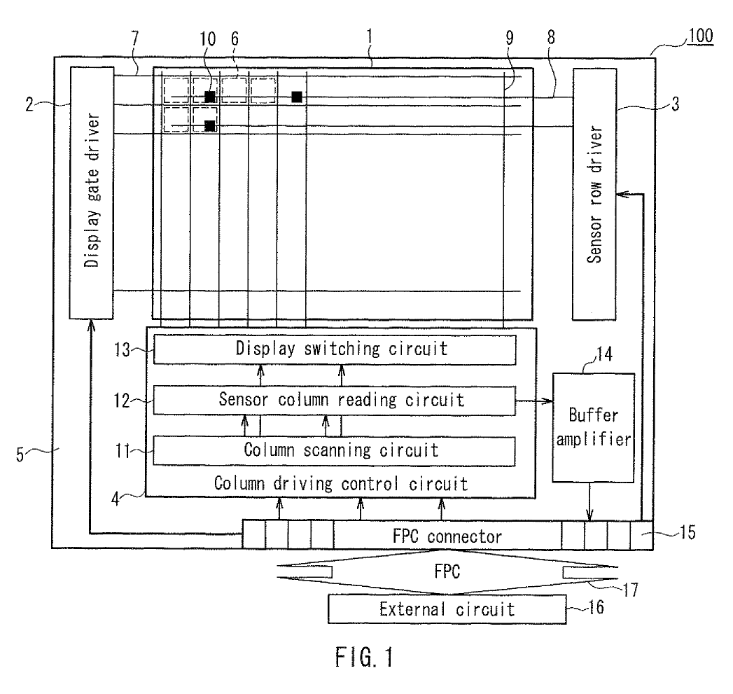

FIG. 1 is a block diagram showing a schematic configuration of an active matrix substrate 100 included in a liquid crystal display device according to one embodiment of the present invention. As shown in FIG. 1, the active matrix substrate 100 includes, on a glass substrate, a pixel region 1, a display gate driver 2, a sensor row driver 3, and a column driving control circuit 4. Hereinafter, in the description of the present invention, a region on the active matrix substrate 100 which surrounds the pixel region 1 and on which driving circuits, etc. for applying voltages and signals to circuit elements, electrodes, etc. included in the pixel region 1 are formed will be referred to as a peripheral region 5.

On the pixel region 1, a number of picture elements 6 as the smallest units in image display are arranged in a matrix in the row direction and the column direction. Gate lines 7 are arranged in correspondence with to the rows of the picture elements 6, and source lines 9 are arranged in correspondence with the columns of the picture elements 6. Further, a plurality of optical sensors 10 are provided in the pixel region 1. In the active matrix substrate 100 of the display device according to the present embodiment, one optical sensor 10 is formed in every row in correspondence with the rows of the picture elements 6, and one optical sensor 10 is formed in every three adjacent picture elements 6 in the column direction. A sensor row line 8 is provided in every row of the picture elements 6 in correspondence with the optical sensors 10.

In order to display images by applying a predetermined voltage to a pixel electrode (not shown) provided in each picture element 6, the display gate driver 2 is a driver for selectively driving display thin film transistors (TFTs) (also not shown) as switching elements each disposed in each picture element 6 by scanning them in sequence. The gate lines 7 arranged in correspondence with the rows of the picture elements 6 are connected to the display gate driver 2. The display gate driver 2 selectively drives the display TFTs on a row basis by applying voltages to the gate lines 7 in sequence.

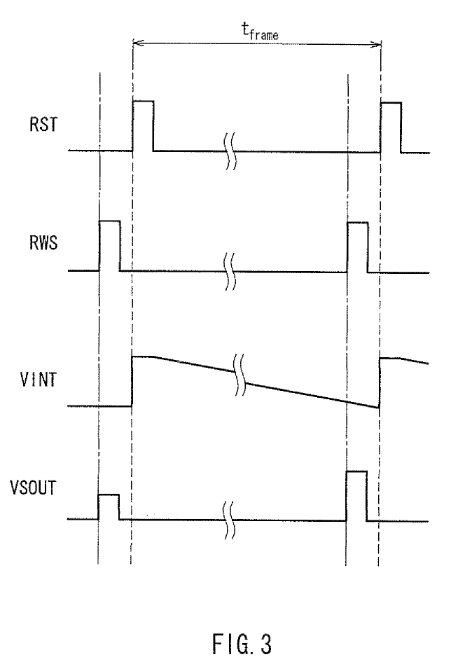

In order to drive the optical sensors 10 arranged in correspondence with the rows of the picture elements 6 by scanning them in sequence, the sensor row driver 3 provides a signal for selecting and resetting the optical sensors 10. The sensor row lines 8 are connected to the sensor row driver 3. In FIG. 1, although each of the sensor row lines 8 is indicated by a single line, it is normally formed by two lines: a RWS line for providing a voltage for turning on sensor driving TFTs to select the optical sensors 10, and a RST line through which reset operation for releasing charges converted by the optical sensors 10 photoelectrically and stored in capacitors is performed. The operation of the optical sensors using the RWS lines and the RST lines will be described later with reference to FIG. 3.

As shown in FIG. 1, the display gate driver 2 and the sensor row driver 3 are placed respectively on the left and the right sides of the pixel region 1. This is because the gate lines 7 drawn to the display gate driver 2 and the sensor row lines 8 drawn to the sensor row driver 3 can be easily drawn from the pixel region 1. Thus, the placement is not necessarily limited to this form, and the positions on which the display gate driver 2 and the sensor gate driver 3 are placed may be exchanged from the left side to the right side and vice versa. Further, there will be no problem even if the display gate driver 2 and the sensor gate driver 3 are both placed on one side of the pixel region 1.

The column driving control circuit 4 is a column driver circuit that supplies voltages to the optical sensors, reads luminance signals from the optical sensors, and drives the display switching elements. That is, the column driving control circuit 4 is a driver circuit with two functions: a function of displaying images by applying in sequence signal potentials for displaying images to the display TFTs (not shown) formed in the respective picture elements 6 in the pixel region 1 to control the molecular alignment of a liquid crystal layer in the respective picture elements 6; and a function of reading photoelectrically-converted luminance signals detected by the optical sensors 10 using the optical sensors 10 arranged in the pixel region 1, and amplifying the luminance signals if needed.

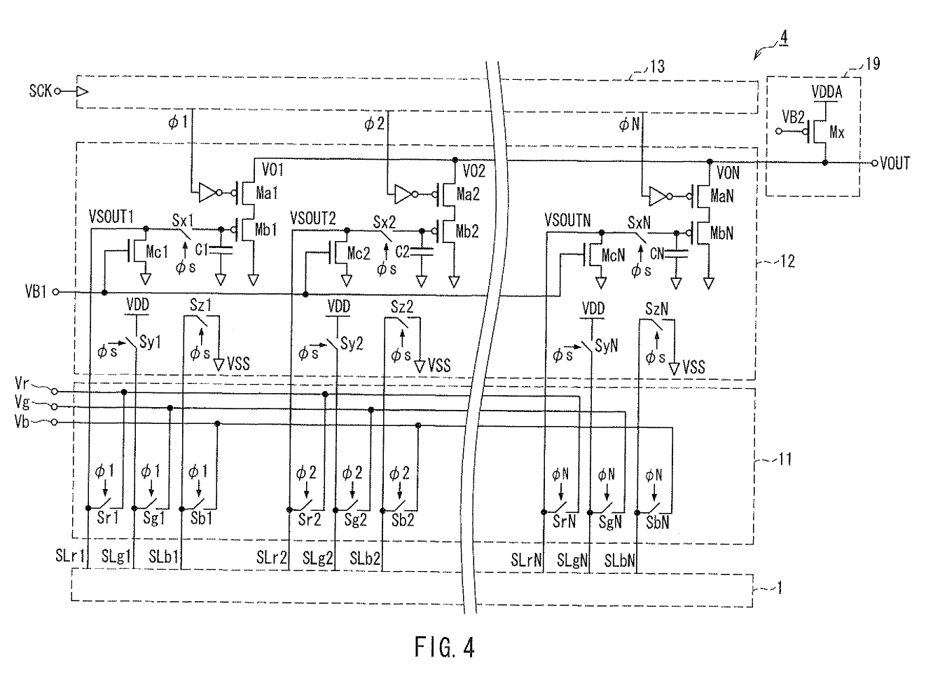

In order to achieve those functions, the column driving control circuit 4 includes: a column scanning circuit 11 for outputting a column selection signal for selectively and sequentially scanning the source lines 9 arranged in correspondence with the columns of the picture elements 6 in the pixel region 1; a sensor column reading circuit 12 for reading the luminance signals from the optical sensors 10 arranged in the pixel region 1 on the basis of the column selection signals from the column scanning circuit 11, and outputting the luminance signals by amplifying them if needed; and a display switching circuit 13 for controlling the molecular alignment of the liquid crystal layer by driving in sequence the display TFTs (not shown) formed in the respective picture elements 6 on the basis of the column selection signal from the column scanning circuit, and applying predetermined signal potentials to the pixel electrodes (also not shown) provided in the respective picture elements 6. It should be noted that details of the column driving control circuit 4 will be described later with reference to FIG. 4. The active matrix substrate 100 of the display device according to the present embodiment further includes: a buffer amplifier 14 for amplifying the luminance signals from the optical sensors 10 outputted from the column driving control circuit 4; and an FPC connector 15 on which an FPC 17 as a connector for connecting the active matrix substrate 100 with an external circuit 16 is mounted. As shown FIG. 1, these buffer amplifier 14 and FPC connector 15 are placed on the side of the peripheral region 5 where the column driving control circuit 4 is provided (the lower side of the pixel region 1 in FIG. 1).

By forming the buffer amplifier 14 and the FPC connector 15 on the side of the peripheral region 5 where the column driving control circuit 4 is provided, the length of wirings for connecting the column driving control circuit 4 with the buffer amplifier 14 and the FPC connector 15 can be reduced. By reducing the length of the wirings formed on the peripheral region 5, it is possible to prevent a signal voltage from being dropped due to an effect caused by the resistance of a material of which the wirings are made. Further, by reducing a necessary signal voltage level, power consumption can be reduced. Furthermore, in a case where the wirings are routed in the peripheral region 5, it is possible to prevent the occurrence of noise due to interference of signal voltages among the adjacent wirings. As a result, high-quality display images can be displayed and the luminance signals obtained from the optical sensors 10 can be obtained at a high S/N ratio. However, it is needless to say that the positions where the buffer amplifier 14 and the FPC connector 15 are placed are not limited to those in the present embodiment for effectively preventing an increase in the wiring resistance due to the length of the wirings and the occurrence of noise due to the routing of the wirings.

Further, by displaying images and reading the luminance signals from the optical sensors with the single column driver circuit, it is possible to reduce power consumption required by the driver circuit in comparison with a case where both a column driver for displaying images and a column driver for optical sensors are provided.

It should be noted that the external circuit 16 in the present invention is a generic name of circuits that are formed on portions other than on the active matrix substrate 100 and are for applying signals and predetermined driving voltages for displaying images at the active matrix substrate 100 and detecting a touched position as, for example, a touch panel on the basis of the luminance signals from the optical sensors 10 provided on the active matrix substrate 100. Further, besides using the FPC as illustrated, a variety of methods for connecting such an external circuit 16 with the active matrix substrate 100 have been proposed.

Furthermore, it should be noted that the components provided on the active matrix substrate 100 can be also formed monolithically on the glass substrate using a semiconductor process. Or, the drivers among the components may be mounted on the glass substrate using a chip on glass (COG) technique or the like. The active matrix substrate 100 is attached to a counter substrate (not shown) on which a counter electrode is formed entirely, the space between the two substrates is filled with a liquid crystal material to form a liquid crystal layer, and functions as a liquid crystal display device.

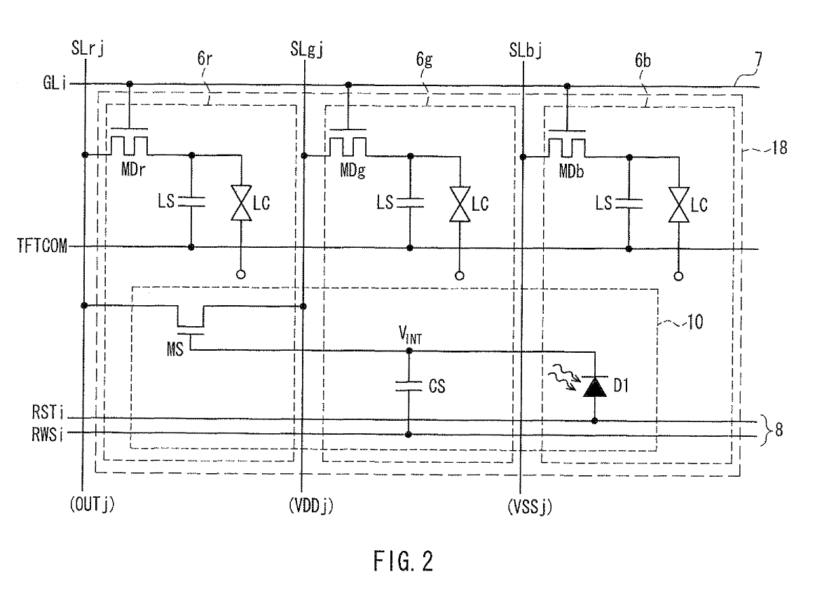

Next, the configuration of the pixel region 1 of the display device according to the present embodiment will be described with reference to FIG. 2.

FIG. 2 is an equivalent circuit diagram showing the placement of the pixel 18 and the optical sensor 10 in the pixel region 1 of the active matrix substrate 100. In the example shown in FIG. 2, one pixel 18 is composed of picture elements of three colors: a red (R) picture element 6r, a green (G) picture element 6g and a blue (B) picture 6b. One optical sensor 10 is provided in one pixel 18 composed of the three picture elements. Consequently, the pixel region 1 includes the pixels 18 arranged in a matrix of M rows×N columns and the optical sensors 10 also arranged in a matrix of M rows×N columns. It should be noted that since the number of the picture elements 6 is three times as large as that of the pixels 18 as described above, the number of the picture elements 6 is M×3N.

The pixel region 1 includes the gate lines (GL) 7 and the source lines (SL) 9 both arranged in a matrix as the lines used for displaying images. The gate lines GL are connected to the display gate driver 2. The source lines SL are connected to the column driving control circuit 4. The number of the gate lines GL provided in the pixel region 1 is M. Hereinafter, when it is necessary to describe the gate lines GL by distinguishing one another, they will be referred to as the gate lines GLi (i=1 to M). On the other hand, every pixel 18 is provided with the three source lines SL in order to supply image data for displaying images to the three respective picture elements 6r, 6g, and 6b in one pixel 18, as described above. When it is necessary to describe the source lines SL individually by distinguishing one another, they will be referred to as the source lines SLrj, SLgj, and SLgj (j=1 to N) respectively corresponding to the red picture element 6r, the green picture element 6g, and the blue picture element 6b. Display TFTs (MDs) are provided at points of intersection of the gate lines GL and the source lines SL as switching elements for displaying images at the corresponding picture elements 6. In FIG. 2, the display TFTs (MDs) provided in the red picture element 6r, the green picture element 6g, and the blue picture element 6b are denoted by reference numerals MDr, MDg, and MDb, respectively. The gate electrodes, the source electrodes, and the drain electrodes of the display TFTs (MDs) are connected to the gate lines GL, the source lines SL, and pixel electrodes (not shown), respectively. Cosenquently, a liquid crystal capacitor LC is formed between each of the drain electrodes of the display TFTs (MD) and the counter electrode. Further, an auxiliary capacitor LS is formed between each of the drain electrodes of the display TFTs (MDs) and each common electrode (TFTCOM).

In FIG. 2, the picture element 6r driven by the display TFT (MDr) connected to the point of intersection of the gate line GLi and the source line SLrj is provided with a red color filter so that the color of the filter matches this picture element 6r. This picture element functions as a red picture element by receiving red image data from the display switching circuit 13 of the column driving control circuit 4 through the source line SLrj. The picture element 6g driven by the display TFT (MDg) connected to the point of intersection of the gate line GLi and the source line SLgj is provided with a green color filter so that the color of the filter matches this picture element. This picture element functions as a green picture element by receiving green image data from the display switching circuit 13 through the source line SLgj. Furthermore, the picture element 6b driven by the display TFT (MDb) connected to the intersection point of the gate line GLi and the source line SLbj is provided with a blue color filter so that the color of the filter matches this picture element. This picture element functions as a blue picture element by receiving blue image data from the display switching circuit 13 via the source line SLbj.

As shown in FIG. 2, the optical sensor 10 is composed of a photodiode D1, a sensor capacitor CS, and a sensor driving TFT (MS) as a sensor switching element. In the example shown in FIG. 2, the source line SLgj serves also as a line VDDj for supplying a constant voltage to the sensor driving TFT (MS) of the optical sensor 10 from the sensor column reading circuit 12 of the column driving control circuit 4. Further, the source line SLrj serves also as an output line OUTj through which the luminance signal as an output signal from the optical sensor 10 is outputted. The circuit components of the optical sensor 10 are not connected to the source line SLbj. As will be described later with reference to FIG. 3, when reading the luminance signal from the optical sensor 10, the line SLb is maintained at a reference potential VSS so as to prevent noise from being generated due to a floating potential. When attention is directed to the function of reading the luminance signal by driving these optical sensors 10, a group of the line VDD and the line OUT is provided in every column of the pixels 18. Thus, when it is necessary to distinguish those lines from one another, they will be referred to as lines VDDj and OUTj (j=1 to N), respectively. It should be noted that in the present embodiment, one pixel 18 includes one TFT as a switching element for reading the luminance signal by driving the optical sensor 10.

Further, a line RSTi for supplying a reset signal is connected to the anode of the photodiode D1. One electrode of the sensor capacitor CS and the gate of the sensor driving TFT (MS) are connected to the cathode of the photodiode D1. The drain of the sensor driving TFT (MS) is connected to the line VDDj and the source is connected to the line OUTj. The other electrode of the sensor capacitor CS is connected to a line RWSi for supplying a signal for reading the luminance signal from the sensor. As described with reference to FIG. 1, the line RSTi and the line RWSi are connected to the sensor row driver 3 and they form the sensor row line 8. Further, these lines RSTi and RWSi are provided in every row. Thus, when it is necessary to distinguish them from one another, they will be referred to as lines RSTi and RWSi (i=1 to M), respectively.

Here, voltages that are applied to the lines RST and RWS and reading of the luminance signal from the optical sensor 10 will be described with reference to FIG. 3.

FIG. 3 is a timing chart showing a general relationship among a rest signal applied to the line RST, a reading signal applied to the line RWS, a potential VENT at the cathode of the photodiode D1 of the optical sensor 10, and an output signal voltage VSOUT outputted to the line OUT.

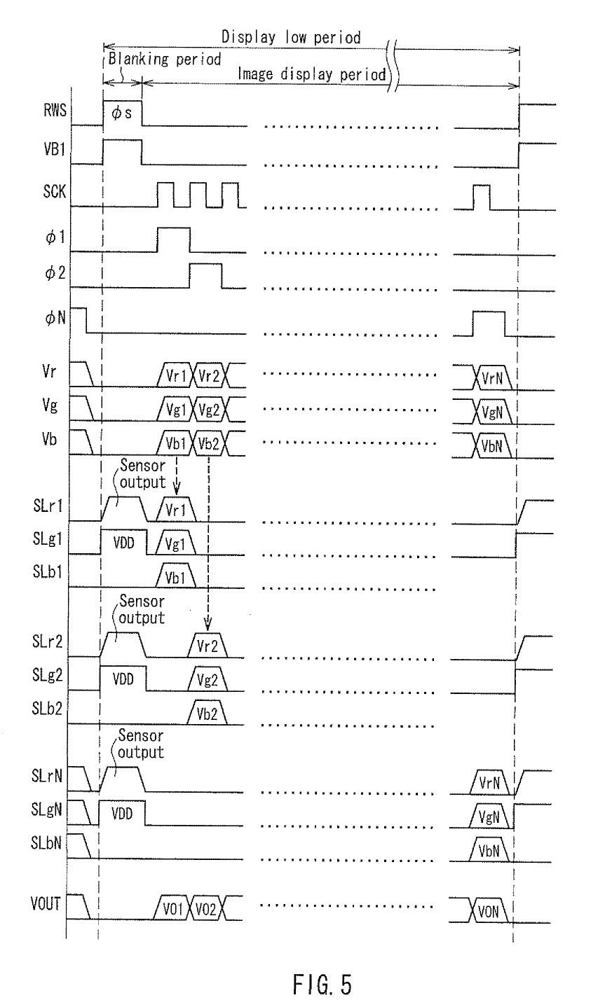

As shown in FIG. 3, the sensor row driver 3 selects the groups each consisting of the line RST and the line RWS in sequence at every selection time t_{frame}. At the beginning of the selection time t_{frame}, the rest signal is applied to the anode of the photodiode D1 through the line RST. During a period in which the reset signal is being applied to the anode of the photodiode D1, the cathode potential VINT of the photodiode D1 is maintained at the same potential as the reset signal and then is reset. After the application of the reset signal ends, the sensor capacitor CS stores a charge in accordance with the amount of light received by the photodiode D1, and the cathode voltage VINT of the photodiode D1 declines gradually. At the end of the selection time t_{frame}, the reading signal is applied to the sensor capacitor CS through the line RWS, and an inversion voltage of the cathode voltage VINT is read through the line OUT as the output signal voltage VSOUT from the optical sensor. Although the reading of the luminance signal from the optical sensor has been described with reference to the general timing chart of FIG. 3 where the selection time t_{frame} continues, a period corresponding to the selection time t_{frame} does not continue in the display device according to the present embodiment as shown in the timing chart of FIG. 5.

Next, the configuration of the column driving control circuit 4 and column driving control at the active matrix substrate according to the present embodiment will be described with reference to FIGS. 4 and 5. FIG. 4 is a block circuit diagram showing the configuration of the column driving control circuit 4. Further, FIG. 5 is a timing chart showing the reading of luminance signals from the optical sensors and the operation of image display in one image display low period (horizontal scanning period).

As shown in FIG. 4, the column driving control circuit 4 includes the column scanning circuit 11, the sensor column reading circuit 12, and the display switching circuit 13. Further, a bias transistor amplifier 19 is provided at an output end of the sensor column reading circuit 12.

The column scanning circuit 11 generates column scan pluses φ1 to φN as column selection signals at a predetermined interval on the basis of scan clock signals SCK inputted thereto. Since the period in which the column scan pulses φ1 to φN are generated is a period in which images are displayed on the basis of the column scan pulses φ1 to φN, hereinafter this period will be referred to as an image display period. On the other hand, an image signal includes, at the beginning of one display low period (horizontal scanning period), a so-called blanking period as an interval period in which column scanning is not performed. The column scan pulses φ1 to φN are not generated in this blanking period. The blanking period and the image display period are specified in the timing chart of FIG. 5.

The sensor column reading circuit 12 includes, in every column of the pixels 18, a first transistor Ma, a second transistor Mb, a capacitor C, and a third transistor Mc. The column scan pluses φ1 to φN are inputted to the gate of each first transistor Ma. The second transistor Mb forms a source follower column amplifier with the first transistor Ma. One end of the capacitor C is connected to the gate of the second transistor Mb. The drain of the third transistor Mc is connected to the gate of the second transistor Mb through a first switch Sx.

The source line SLr formed in the pixel region 1 is connected to the drain of the third transistors Mc. As described above, since SLr serves also as the line OUT as a signal output line of the optical sensor 10, the output signal VSOUT is transmitted to the sensor column reading circuit 12 through SLr. A first bias voltage VB1 is applied to the gate of the third transistor Mc. Further, the source of the first transistor Ma is connected to the bias transistor amplifier 19 through the output end of the sensor column reading circuit 12.

The source line SLg formed in the pixel region 1 is connected to a reference voltage VDD through a second switch Sy and the other source line SLb is connected to a reference potential VSS through a third switch Sz. VSS is typically 0V. It should be noted that the drain of the second transistor Mb, the source of the third transistor Mc, and the other terminal of the capacitor C are all connected to the reference potential VSS.

As shown in FIG. 4, in the sensor column reading circuit 12, the above configuration is repeated in the same manner in every column of the pixels 18 in the pixel region 1. Therefore, when it is necessary to describe the circuit elements of the sensor column reading circuits 12 individually, the first transistors will be referred to as Maj, the second transistors will be referred to as Mbj, the third transistors will be referred to Mcj, the first switches will be referred to as Sxj, the second switches will be referred to as Syj, the third switches will be referred to as Szj, and the capacitors will be referred to as Cj (j=1 to N).

To the picture elements 6r, 6g, and 6b respectively corresponding to three colors of red, green and blue, in order to apply image signals of their colors in accordance with the column scan pulses φ1 to φN from the column scanning circuit 11, the display switching circuit 13 includes, in every column of the pixels 18, an R switch Sr for connecting a red image signal Vr and the source line SLr; a G switch Sg for connecting a green image signal Vg and the source line SLg; and a B switch Sb for connecting a blue image signal Vb and the source line SLb. As shown in FIG. 4, also in the display switching circuit 13, the above configuration is repeated in the same manner in every pixel 18 of the pixel region 1, and is repeated N times in correspondence with the number of the 1st to N th pixels 18. Therefore, when it is necessary to describe the circuit elements of the sensor column reading circuits 13 individually, the R switches, the G switches, and the B switches will be referred to as Srj, Sgj and Sbj, respectively (j=1 to N).

Further, the column driving control circuit 4 according to the present embodiment includes the bias transistor amplifier 19 provided adjacent to the output end of the sensor column reading circuit 12. The bias transistor amplifier 19 includes a column source follower bias transistor Mx. A second bias voltage VB2 is applied to the gate of the column source follower bias transistor Mx and a supply voltage VDDA is applied to the drain.

Next, the reading operation of luminance signals from the optical sensors 10 and the image display operation at the pixel region 1 in the display device according to the present embodiment will be described with reference to FIG. 5. As described above, one display low period (horizontal scanning period) shown in FIG. 5 is composed of a blanking period in which images are not displayed and an image display period in which images are displayed. In the display device according to the present embodiment, the sensor column reading circuit 12 reads luminance signals from the optical sensors 10 during the blanking period and the sensor column reading circuit 12 outputs the luminance signals from the respective optical sensors 10 to the outside during the image display period.

As shown in FIG. 5, signals φs are applied to the lines RWS during the blanking period. It should be noted that the signals φs are also treated as column scan signals in the description of the present embodiment. At this time, the second switches Sy in the sensor column reading circuit 12 are turned on during the period in which the signals cps are being applied to the lines RWS, as shown in FIG. 4. Thus, the voltages VDD are applied to the source lines SLg as the lines VDD of the optical sensors 10, and the voltages VDD are supplied to the sensor TFTs (MSes) forming the optical sensors as shown in FIG. 2. As shown in FIG. 4, since the signals cps are applied to the optical sensors 10 in all of the columns in the same manner, among the optical sensors 10 formed in the pixel region 1, the voltages VDD are applied to all of the optical sensors 10 in one row selected by the sensor row driver 3, and the optical sensors 10 operate. Then, in accordance with the reading signals of the lines RWS each forming the sensor row line 8, charges stored in the sensor capacitors CS are outputted as signal outputs VSOUT through the lines OUT, in other words, the source lines SLr.

Similarly, as shown in FIG. 4, in the sensor column reading circuit 12, the third transistors Mc are turned on due to the first bias voltages VB1 being applied to their gates. At the same time, the first switches Sx are also turned on, and the source lines SLr and the capacitors C of the sensor column reading circuit 12 are connected to each other. As a result, the output signals VSOUT outputted from the optical sensors 10 are stored respectively in the capacitors C in the corresponding columns in the sensor column reading circuit 12. The signal charges as the output signals VSOUT from the optical sensors 10 to the sensor column reading circuit 12 are transferred in the blanking period from all of the N optical sensors in the row selected by the sensor row driver 3. FIG. 5 shows that sensor output signals are generated on all of the source lines SLr1, SLr2 . . . SLrN.

Next, during the image display period after the blanking period ended, the column scanning circuit 11 generates the column scan pluses φ1 to φN in sequence in accordance with on and off timings of the scan clock signal SCK. At this time, the 1st to Nth pixels 18 formed in the row selected by the display gate driver 2 are selected in sequence in the column direction in accordance with the column scan pulses φ1 to φN. In the display switching circuit 13, the R switch Sr, the G switch Sg, and the B switch Sb corresponding to the selected pixel are turned on at the same time, and image signals respectively corresponding to red, green, and blue for displaying images are applied to the display TFTs (MDs) formed in the red, green and blue picture elements 6 forming each pixel 18. Due to this operation being performed on all of the rows formed by the pixels 18 by the display gate driver 2 scanning the rows in sequence, images are displayed at the pixel region 1.

At the same time, due to the column scan pulses φ1 to φN generated by the column scanning circuit 11 being applied to the sensor column reading circuit 12, an on se is applied to the gate of the first transistor Ma in every column in sequence in the sensor column reading circuit 12. Output signals Voj, which are outputted from the capacitors C storing output signals of the optical sensors 10 formed in the pixels 18 in the selected column, and amplified by source follower column amplifiers each formed by the first transistor Ma and the second transistor Mb in every column in the sensor column reading circuit 12, are outputted from the output end of the sensor column reading circuit 12 in sequence.

In this way, in one display low period, the output signals from the optical sensors 10 formed in the row selected by the sensor row driver 3 are outputted in sequence. Due to this operation being performed by the sensor low driver 3 scanning all of the rows, the luminance signals received by the optical sensors 10 arranged in the pixel region 1 can be outputted from the output end of the sensor column reading circuit 12 as secondary information.

Then, the luminance signals Voj outputted from the output end of the sensor column reading circuit 12 are further amplified by the bias transistor amplifier 19 connected to the output end of the sensor column reading circuit 12, and are outputted as VOUT.

In the present embodiment, an example where the output signals from the optical sensors formed in the pixel region are first amplified by the column amplifiers formed in every column in the sensor column control circuit, and then are further amplified by the bias transistor amplifier has been described. However, the present invention is not limited to this example, and the amplification of the output signals in the sensor column control circuit may be performed only by the column amplifiers on a column, basis. Or the amplification may be performed only by the amplifier that amplifies the outputs from all of the columns. Furthermore, it is also possible to choose an option not to amplify the output signals in the sensor column control circuit by providing an amplifier outside the sensor column control circuit.

### Embodiment 2

Next, as Embodiment 2 of the present invention, a case where images are displayed by a display device by so-called multiphase driving will be described.

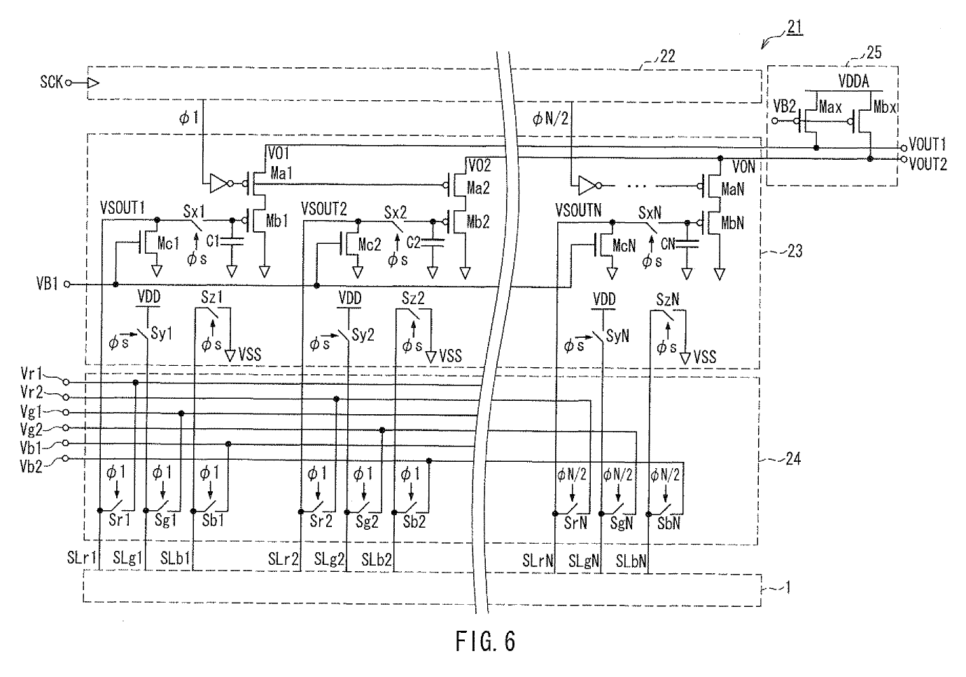

FIG. 6 is a block circuit diagram showing the configuration of a column driving control circuit 21 of a display device according to Embodiment 2. As shown in FIG. 6, the column driving control circuit 21 includes a column scanning circuit 22, a sensor column reading circuit 23, and a display switching circuit 24. Further, a bias transistor amplifier 25 is provided at an output end of the sensor column reading circuit 23.

The column scanning circuit 22 generates column scan pulses φ1 to φN/2 at a predetermined interval on the basis of scan dock signals SCK inputted thereto. In the present embodiment, two-phase driving will be described as an example of multiphase driving. Thus, the column scan pulses only need to be ½ of those in Embodiment 1 shown in FIG. 4. As same as in Embodiment 1, a period in which the column scan pulses φ1 to φN/2 are generated is an image display period, and this image display period and a blanking period form one display low period (horizontal scanning period).

As same as the sensor column reading circuit 12 described in Embodiment 1, the sensor column reading circuit 23 includes, in correspondence with each pixel column, the first transistor Maj, the second transistor Mbj, the third transistor Mcj, the first switch Sxj, the second switch Syj, the third switch Szj, and the capacitor Cj (j=1 to N), and the connections of the respective circuit elements are also same as those in Embodiment 1 except that the source of the first transistor Ma is connected to the transistor amplifier 19 through the output end of the sensor column reading circuit 12 as a dual output signal line. Thus, the detail descriptions of the portions common to those shown in FIG. 4 will not be repeated.

Two-phase driving described in the present embodiment is different from the drive in Embodiment 1 in that the column scan pulses φ1 generated by the column scanning circuit 22 is applied to the gates of both the first transistor Mal corresponding to the first pixel column and the second transistor ma corresponding to the second pixel column; in other words, the same column scan pulse is applied to every two pixel columns.

Similarly to Embodiment 1, in the display switching circuit 24, the R switch Sri the G switch Sgj, the B switch Sbj (j=1 to N) are provided in correspondence with each column. The two-phase driving in the present embodiment is characterized by each of red, green, and blue image signals having two phases: Vr1 and Vr2, Vg1 and Vg2, and Vb1 and Vb2, respectively. Thus, the difference from Embodiment 1 is that the first-phase image signals Vr1, Vg1, and Vb1 are applied to the source lines SLr1, SLg1, and SLb1 in the first pixel column, respectively, and the second-phase image signals Vr2, Vg2, and Vb2 are applied to the source lines SLr2, SLg2, and SLb2 in the second pixel column, respectively. Due to the applied image signals having different phases, the same column scan pulse can be applied to every two columns to display images.

In order to cope with a dual output from the sensor column reading circuit 23, the bias transistor amplifier 25 also includes two column source follower bias transistors Max and Mbx whose gates are applied with a second bias voltage VB2. The transistor Max corresponds to the first-phase output and the transistor Mbx corresponds to the second-phase output.

In Embodiment 2, the display device using two-phase driving has been described as an example of multiphase driving. However, by applying the idea of the present embodiment, it is also possible to support for multiphase driving of three or more phases. Consequently, it is possible to easily obtain a display device with a multiphase-driven sensor function having a high-speed response, which is capable of increasing the definition of displayed images and displaying images with high-speed response, both of which are advantages of multiphase driving.

### Embodiment 3

Next, as Embodiment 3 of the present invention, a case where the number of phases used in driving the display switching elements is twice as large as the number of phases used in reading luminance signals from the optical sensors will be described as yet another example of a display device that displays images by so-called multiphase driving.

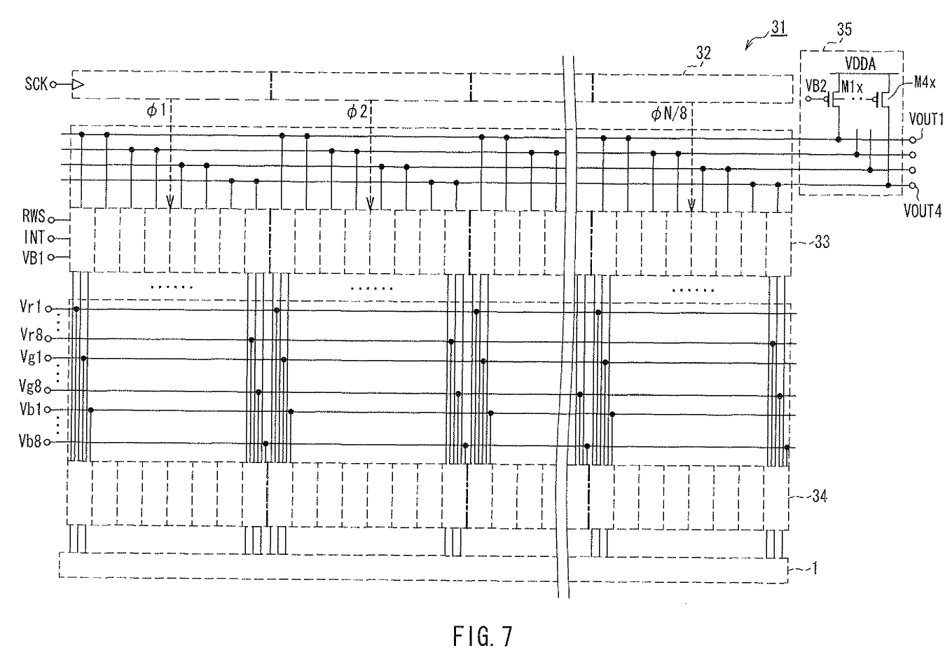

FIG. 7 is a schematic diagram showing the configuration of a column driving control circuit 31 of a display device according to Embodiment 3 in such a manner that the concept of phases in multiphase driving is specified. The column driving control circuit 31 according to the present embodiment includes a column scanning circuit 32, a sensor column reading circuit 33, and a display switching circuit 34.

In the present embodiment, images are displayed by eight-phase driving. Therefore, as shown in FIG. 7, the column scanning circuit 32 generates column scan pulses φ1 to φN/8. The sensor column reading circuit 33 reads luminance signals from first to eighth pixels in accordance with one column scan pulse from the column scanning circuit 32, for example, the column scan pulse φ1, then combines together luminance signals from every two adjacent pixels, for example, the first and the second pixels, the third and the fourth pixels, the fifth and the sixth pixels, and the seventh and the eighth pixels, and outputs the resultants as output signals of four phases. It should be noted that dashed lines shown in the sensor column reading circuit 33 and the display switching circuit 34 indicate boundaries of the pixels 18, each of which is composed of the red, green, and blue picture elements 6.

The luminance signals outputted from the sensor column reading circuit 33 are sent to the bias transistor amplifier 3 to be amplified. It should be noted that in correspondence with the sensor outputs of four channels, i.e., four phases, the bias transistor amplifier 35 also includes four column source follower bias transistors Mix to M4x whose gates are applied with second bias voltages VB2. The transistor Mix corresponds to the first-phase output VOUT1, M2x corresponds to the second-phase output VOUT2, Max corresponds to the third-phase output VOUT3, and M4x corresponds to the fourth-phase output VOUT4.

Red, green, and blue image signals are each divided into eight phases; Vr1 to Vr8, Vg1 to Vg8, and Vb1 to Vb8, and they are respectively applied by the display switching circuit 34 to display TFTs for performing switching operation for displaying images provided in the corresponding red, green and blue picture elements 6 forming the first to the eighth pixels 18.

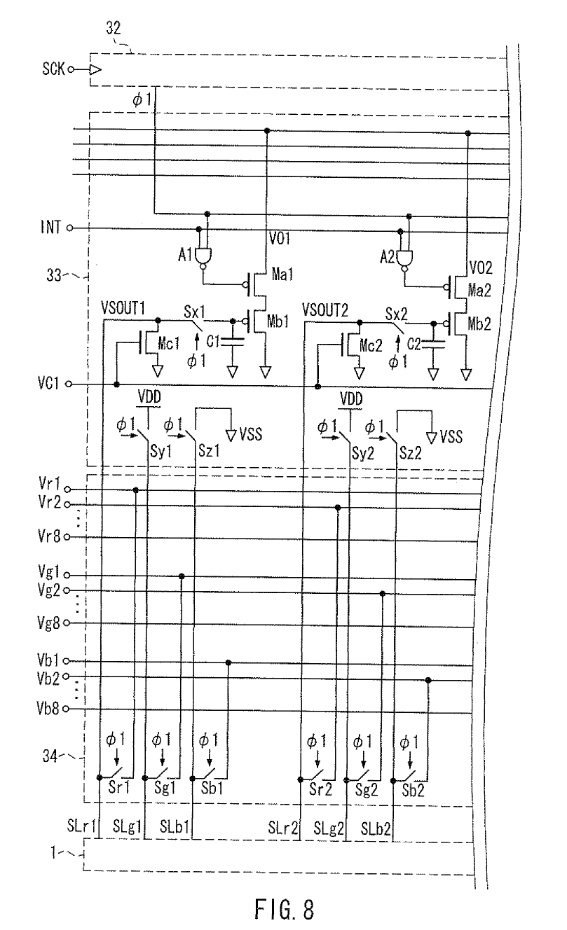

Next, the circuit configurations of the sensor column reading circuit 33 and the display switching circuit 34 in the column driving control circuit 31 of the display device according to the present embodiment will be described with reference to FIG. 8.

FIG. 8 is a block diagram showing the circuit configurations of the sensor column reading circuit 33 and the display switching circuit 34 according to the present embodiment. It should be noted that, in each circuit, the portions corresponding to only the first and the second pixel columns are shown for the sake of simplicity.

As shown in FIG. 8, also in the sensor column reading circuit 33 according to the present embodiment, the circuit configuration of the portion corresponding to one pixel is same as in the sensor column reading circuit 12 according to Embodiment 1 described with reference to FIG. 4, and in the sensor column reading circuit 23 according to Embodiment 2 described with reference to FIG. 6. That is, the sensor column reading circuit 33 includes the first transistor Mal, the second transistor Mb1, the third transistor Mc1, and further the first switch Sx1, the second switch Sy1, the third switch Sz1, and the capacitor C1 in correspondence with the first pixel column. It is needless to say that this configuration is repeated N times (j=1 to N) in the sensor column reading circuit 33 as a whole. Further, the connections of these circuit components are basically the same as those shown in FIGS. 4 and 6.

The sensor column reading circuit 33 illustrated in the present embodiment is different from the column reading circuits in Embodiments 1 and 2 in that the sensor column reading circuit 33 includes: a first AND circuit A1 for applying to the first transistor Mal an AND of the scan pulse signal φ1 and a voltage applied to an INT line to which an interval signal for switching output amplifiers corresponding to two adjacent pixel columns; and a second AND circuit A2 for applying to the second transistor Mat an AND of the scan pulse φ1 and an inverted signal of the voltage applied to the INT line. The reason for this is as follows. In contrast to displaying images by eight-phase driving, outputs from the sensors are read by four-phase driving in the present embodiment, which is ½ of that used in displaying images. Thus, outputs from every two adjacent pixel columns need to be outputted in sequence from the output line of the same phase.

On the other hand, the display switching circuit 34 is configured to deal with each of image signals that are applied as signals of eight phases in order to support for eight-phase driving. At the portion corresponding to the first pixel shown in FIG. 8, the R switch Sri, the G switch Sg1, and the B switch Sb1 are configured to connect the first-phase red image signal Vr1, the first-phase green image signal Vg1, and the first-phase blue image signal Vb1 respectively with the source lines SLr1, SLg1, and SLb1 of the picture elements of corresponding colors. This configuration is repeated N times (j=1 to N) also in the display switching circuit 34 as a whole.

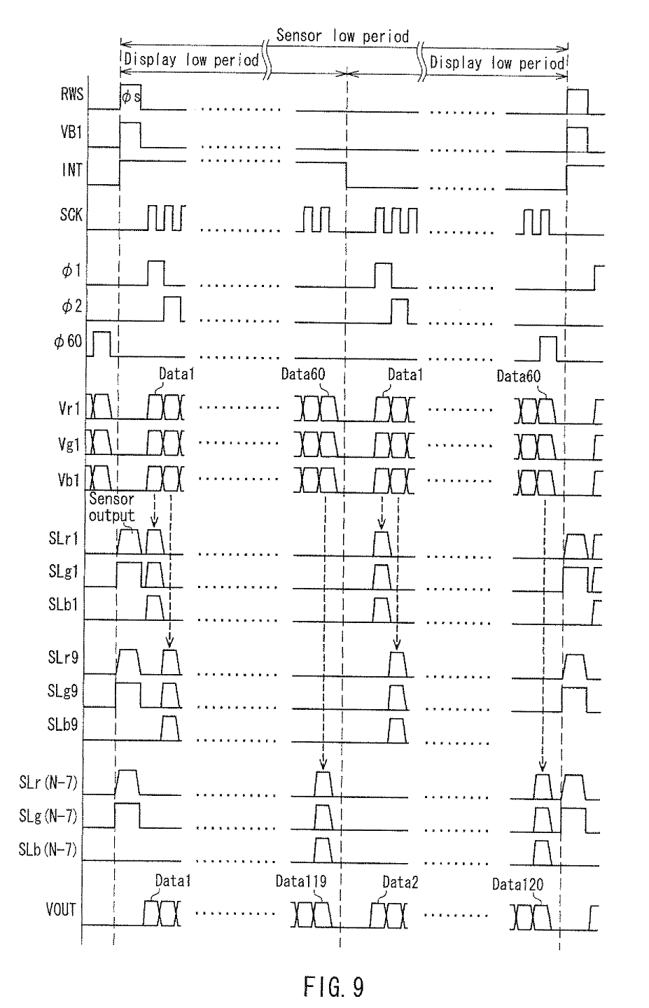

Next, the operation of the column driving control circuit 31 according to the present embodiment will be described with reference to FIG. 9.

FIG. 9 is a timing chart showing the operation of the column control driving circuit 31 of the display device according to Embodiment 3. Although both displaying of images and reading of outputs from the optical sensors are performed by multiphase driving, in FIG. 9, only the operations of both displaying of images and the optical sensors in the first phase will be described as an example.

As shown in FIG. 9, in the display device according to the present embodiment, image are displayed by eight-phase driving and outputs are read from the optical sensors 10 by four-phase driving. Therefore, two display low periods correspond to one sensor low period. It should be noted that the operation of each pixel and each of red, green, and blue picture elements forming each pixel itself is same as those in the display device according to Embodiment 1 described with reference to FIG. 5. Thus, the descriptions of these common portions will not be repeated for the sake of simplicity.

In the present embodiment, output signals from the optical sensors 10 formed in the pixels are read during the blanking period of a first display low period of a sensor low period. As shown in FIG. 9, to the line RWS, the signal φs is applied and at the same time the first bias voltage VB1 is also applied, and a luminance signal from each optical sensor 10 provided in each pixel in the pixel region 1 is read by the sensor reading circuit 33.

During the image display period in the first display low period of the sensor low period, by an interval signal INT being turned ON, 1st, 3rd, 5th, . . . 119th odd-numbered data among the luminance signals read during the blanking period are outputted from the sensor column reading circuit 33 in accordance with the on and off timings of a scan dock signal SCK at which image display signals are inputted.

Luminance signals from the optical sensors 10 formed in the pixels are not read during the blanking period of the second display low period of the sensor low period. And during the image display period of the second display low period subsequent to the blanking period, by an interval signal INT being turned OFF, among the luminance signals read during the blanking period of the first display low period, 2nd, 4th, 6th, . . . 120th even-numbered data that has not yet been outputted is outputted from the sensor column reading circuit 33 in accordance with the on and off timings of the scan dock signal SCK at which image display signals are inputted. With respect to displaying images, also during the second display low period, image signals to be displayed are respectively applied to the corresponding picture elements of red, green, and blue on the basis of the first-phase image signals, and the first-phase image display is performed.

In the present embodiment, since images are displayed by so-called eight-phase driving, by repeating four times the above-described configuration of performing reading of sensor outputs in one sensor low period in correspondence with displaying images in two display low periods, image are displayed by eight-phase driving and outputs from the sensors are read by four-phase driving.

In this way, when the number of phases used in driving the display switching elements is twice as large as that used in reading luminance signals from the optical sensors, output signals are read from the optical sensors once while the display switching elements are driven twice by multiphase driving. Therefore, in the case of so-called frame inversion driving generally used as driving in liquid crystal display devices where the polarities of the counter substrate are switched every phase, the polarity of the counter electrode at the time of reading output signals from the optical sensors can be always maintained at the same polarity. As a result, an influence that a parasitic capacitance in each picture element has on a sensor output signal becomes even, and thereby the precision of the optical sensor output signal can be improved. In the above embodiments, a case where images are displayed by eight-phase driving and outputs from the optical sensors are read by four-phase driving has been described. This is because eight-phase driving is commonly used to display images as multiphase driving in the current circuit technology. As long as the number of phases used in driving display switching elements is twice as large as that used in reading luminance signals from the optical sensors, it is possible to achieve the effect of the present embodiment, i.e., preventing the parasitic capacitances from affecting the optical sensor reading signals in the frame inversion driving. Therefore, a case where images are displayed by four-phase driving and outputs from the optical sensors are read by two-phase driving or a case where, if images can be displayed by sixteen-phase driving, outputs from the optical sensors are read by eight-phase driving may be considered.

With respect to the display device with a sensor function of the present invention, there has been described, by illustrating the specific embodiments, the configuration capable of improving the aperture of each picture element by using the source lines used for displaying images to drive the optical sensors and to output signals and also capable of reducing the size of the frame region of the active matrix substrate and power consumption by driving the columns to display images and to read signals from the optical sensors using a single column driving control circuit. The display device of the present invention, however, can take a variety of forms in addition to the embodiments described above.

An example in which one optical sensor is provided in every pixel composed of three picture elements has been described in the above embodiments. However, when the optical sensors do not need to have significantly high resolution, one optical sensor may be provided in every six picture elements across two successive rows.

Further, as an example of the optical sensor formed in every pixel, an optical sensor that includes one sensor driving TFT (MS) as a sensor switching element has been described in the above embodiments. However, the number of the switching element included in the optical sensor is not limited to one.

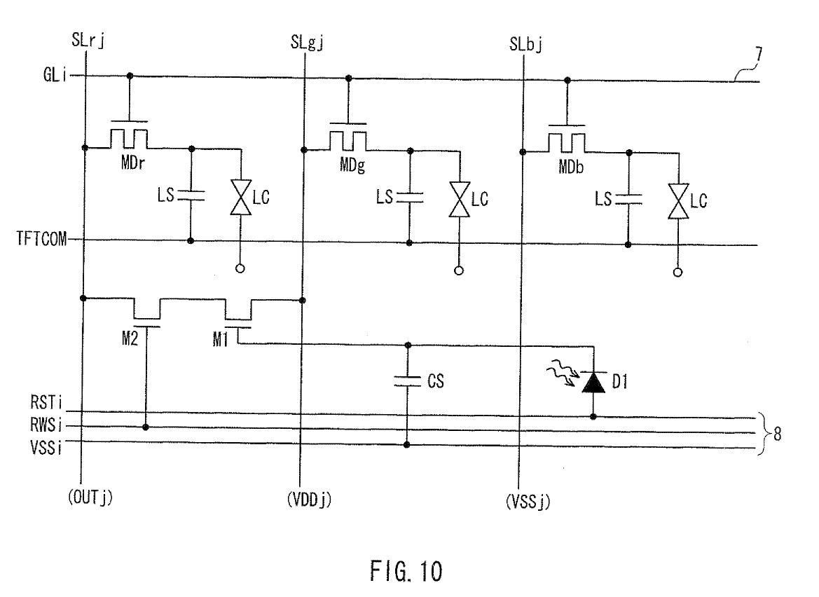

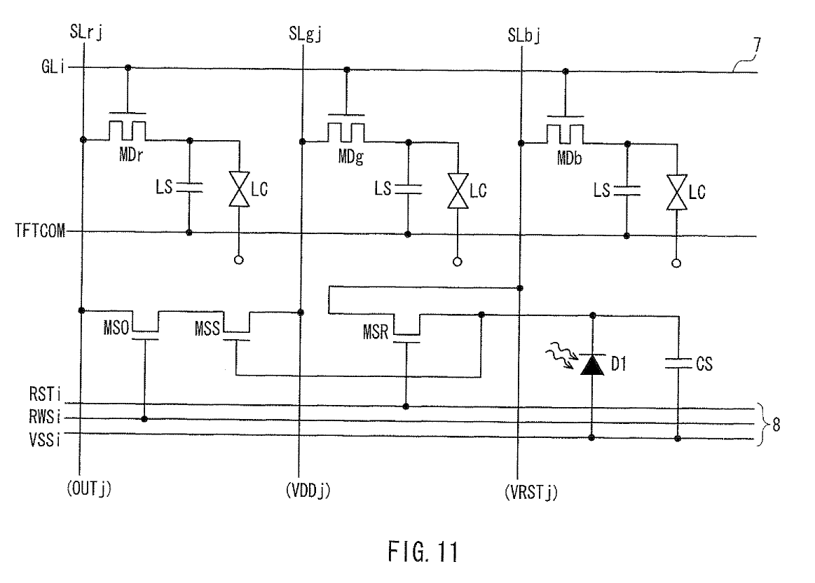

For example, as shown in FIG. 10, an optical sensor including a first TFT (M1) and a second TFT (M2) as switching elements connected to each other in series may be considered. Furthermore, as shown in FIG. 11, an optical sensor including three TFTs, a sensor selection TFT (MSS), a reset TFT (MSR), and a sensor output TFT (MSO), may be considered. By applying these optical sensors in the present invention, it is possible to achieve an effect similar to that achieved by the configuration using the optical sensors including one switching element illustrated in the above embodiments.

It should be noted that as shown in FIGS. 10 and 11, when using two or three sensor TFTs, a line VSSi is provided as one of the lines forming the sensor row line 8 connected to the sensor row driver 3, in addition to the lines RSTi and RWSi. Further, when using three TFTs, SLbj used as a line having a function of VSSj is to be used as VRSTj for adding a reset signal.

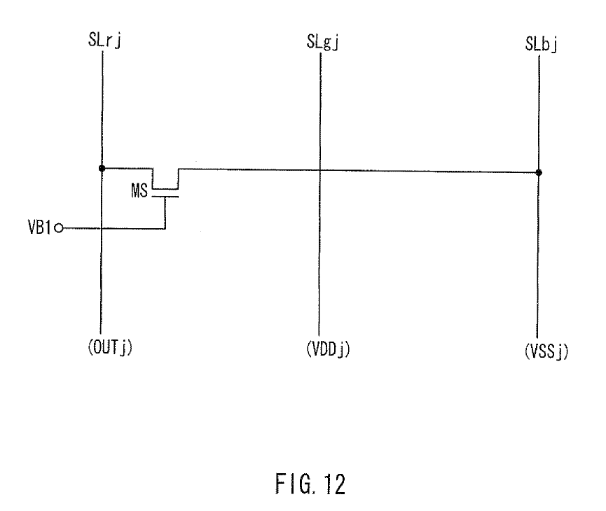

Furthermore, an example of using the third transistor Mcj of the sensor column reading circuit of the column driving control circuit as a transistor for drawing output signals from the optical sensors provided in the pixel region has been described in the above embodiments. However, the place on which the transistor is provided is not limited to the inside of the column driving control circuit. For example, by using a dummy cell normally formed in the immediate vicinity of the pixel region to form a circuit shown in FIG. 12 in every column, these transistors MRO can be used for reading output signals from the optical sensors.

### INDUSTRIAL APPLICABILITY

The present invention is industrially applicable as a display device with an image capture function including optical sensors in the pixels, in particular a display device capable of achieving a reduction in the size of the frame region of an active matrix substrate and in power consumption.

1. A display device comprising an active matrix substrate including a plurality of gate lines, a plurality of source lines, and display switching elements arranged in correspondence with respective points of intersection of the plurality of gate lines and the plurality of source lines, the display device further comprising:
optical sensors provided in a pixel region of the active matrix substrate; and
a plurality of sensor row lines arranged in correspondence with the optical sensors,
wherein supply of a voltage to the optical sensors and reading of a luminance signal from the optical sensors are performed through the plurality of source lines by a common column driver circuit that drives the display switching elements.

2. The display device according to claim 1,
wherein the column driving circuit includes: a column scanning circuit for outputting a column selection signal; a sensor column reading circuit for supplying a voltage to the optical sensors and reading the luminance signal on the basis of the column selection signal; and a display switching circuit for supplying an image display signal to the display switching elements on the basis of the column selection signal.

3. The display device according to claim 2,
wherein the sensor column reading circuit reads the luminance signal from the optical sensors during a blanking period, and the sensor column reading circuit outputs the luminance signal during an image display period.

4. The display device according to claim 2,
wherein the active matrix substrate includes a connector for establishing connection with an external circuit, and
the column driving circuit is formed on a side of a peripheral region where the FPC connector is formed.

5. The display device according to claim 2,
wherein the column driving circuit has a function of amplifying the luminance signal from the optical sensors.

6. The display device according to claim 1,
wherein the optical sensors include one sensor switching element.

7. The display device according to claim 1,
wherein the optical sensors include two sensor switching elements.

8. The display device according to claim 1,
wherein the optical sensors include three sensor switching elements.

9. The display device according to claim 1,
wherein in correspondence with the display switching elements being driven by multiphase driving, the luminance signals from the optical sensors are read by multiphase driving.

10. The display device according to claim 9,
wherein the number of phases used in the multiphase driving of the display switching elements and the number of phases used in the reading of the luminance signals from the optical sensors are equal.

11. The display device according to claim 9,
wherein the number of phases used in the multiphase driving of the display switching elements is twice as large as that used in the reading of the luminance signals from the optical sensors.

12. The display device according to claim 9,
wherein the display switching elements are driven by eight-phase driving and the luminance signal from the optical sensors is read by four-phase driving.

13. The display device according to claim 1, further comprising:
a counter substrate facing the active matrix substrate; and
a liquid crystal layer interposed between the active matrix substrate and the counter substrate.
